(19) United States
(12) Patent Application Publication
(10) Pub. No.: US 2018/0083498 A1
(43) Pub. Date: Mar. 22, 2018

(54) STATOR FOR AN ALTERNATOR OR AN ELECTRICAL MACHINE

(71) Applicant: VALEO EQUIPEMENTS ELECTRIQUES MOTEUR, Creteil Cedex (FR)

(72) Inventors: Eric SIMON, Longjumeau (FR); Matthieu BONNICI, Maisons-Alfort (FR); Olivier SAVINOIS, Saint Honoré Les Bains (FR); Bruno DANDRE, Marconne (FR); Vincent RAMET, Etaples (FR); Stéphane DE CLERCQ, Rang du Fliers (FR); Xavier DUNESME, Yerres (FR); Jean-Francois GAUTRU, Montreuil (FR); Pierre FAVEROLLE, Montgeron (FR)

(73) Assignee: VALEO EQUIPEMENTS ELECTRIQUES MOTEUR, Creteil Cedex (FR)

(21) Appl. No.: 15/524,189

(22) PCT Filed: Oct. 30, 2015
(86) PCT No.: PCT/EP2015/075259

§ 371 Date: May 3, 2017

(30) Foreign Application Priority Data
Nov. 3, 2014 (FR) 1460571

(51) Int. Cl. H02K 1/16; H02K 3/12

(52) U.S. Cl. CPC H02K 1/165; H02K 3/12

(57) ABSTRACT

The invention relates to a stator (13) for an alternator or an electric machine, which comprises: a cylindrical hub (14) in which a plurality of slots (201) that extend in the axial direction are formed, and a coil (12) mounted in the slots; in which the stator core (14) comprises: a cylindrical base portion (203) forming a cylinder head (203), a plurality of teeth (202) arranged such as to extend from the base portion towards an axial center (X-X), the plurality of slots (201) being defined by the base portion and by an adjacent pair of the teeth (202). For each notch (201) the width at the opening of the notch (l_eo) is smaller than the width (l_ec) at the cylinder head (203).

### TECHNICAL FIELD OF THE INVENTION

The present invention relates to a stator for an alternator or for an electrical machine, and it also relates to an alternator or an electrical machine comprising a stator of this type.

The invention has a particularly advantageous application in the field of alternators and alternator starters for motor vehicles.

### TECHNOLOGICAL BACKGROUND OF THE INVENTION

As is known, a rotary electrical machine of the monophase or polyphase type comprises at least two parts which are arranged coaxially, i.e. an armature and an inductor. A first one of the parts surrounds the second one of the parts, which is conventionally integral with a rotary shaft.

The first one of the parts constitutes a stator, whereas the second part constitutes the rotor of the machine.

When the armature is formed by the rotor, this machine constitutes an electric motor, and transforms electrical energy into mechanical energy. This machine transforms mechanical energy into electrical energy when the armature is formed by the stator in order to function as an electric generator, and constitute an alternator for example. It will be appreciated that the electrical machine can be reversible, and can also transform electrical energy into mechanical energy in order to form an alternator-starter of a motor vehicle for example, making it possible in particular to start the internal combustion engine of the motor vehicle whilst having an alternator function.

FIG. 1, which is a half view in cross-section, represents a polyphase rotary electrical machine in the form of an alternator of the three-phase type with internal ventilation for a motor vehicle with an internal combustion engine of the type described in document EP-A-0 515 259, to which reference will be made.

Going from left to right in FIG. 1, i.e. from the front to the rear, the alternator comprises a drive pulley 11 integral with the front end of a shaft 2, the rear end of which supports collector rings 10a, 10b belonging to a collector 1. The axis X-X of the shaft 2 constitutes the axis of rotation of the machine and of the collector.

Centrally, the shaft 2 supports in a fixed manner the rotor 4 provided with an excitation winding 5, the ends of which are connected by wired connections to the collector 1, as can be seen in FIG. 11 of documents FR 2 710 197, FR 2 710 199 and FR 2 710 200. The rotor 4 is in this case a claw rotor and thus comprises two magnet wheels 6, 7 each supporting respectively a front 8 and rear 9 fan, each provided with blades as in document EP-A-0 515 259.

Each wheel has axial teeth which face towards the other wheel with imbrication of the teeth of one wheel with the other, for formation of magnetic poles when the winding 5 is activated by means of the collector rings of the collector 1, each in contact with the brush (with no reference) supported by a brush-holder 100 which in this embodiment is integral with a voltage regulator, not shown. The brushes have radial orientation relative to the axis X-X, whereas the rings 10a, 10b have axial orientation relative to the axis X-X.

The regulator is connected to a device for rectification of alternating current into direct current 110, such as a diode bridge (two of which are shown in FIG. 1), or as a variant, transistors of the MOSFET type, in particular when the alternator is of the reversible type, and consists of an alternator-starter, as described for example in document WO 01/69762. This device 110 is itself connected electrically, firstly to the phase outputs belonging to the windings 12 which the stator 13 of the alternator comprises, and secondly to the on-board network and to the battery of the motor vehicle. This stator 13, which forms an armature in the case of an alternator, surrounds the rotor 4 and comprises a body 14 which is provided in its interior with axial notches (not shown) and windings 12. The axial notches are provided with the wires or pins of the windings 12. These windings 12 have chignons (with no reference) which extend firstly projecting axially from both sides of the body 14, and secondly radially above the fans 8, 9.

For reference, it will be remembered that the voltage regulator serves the purpose of controlling the current which circulates in the excitation winding 5, in order to regulate the voltage supplied to the on-board network and to the battery of the vehicle via the current rectifier device 110.

The fans 8, 9 extend in the vicinity respectively of a front flange, known as the front bearing 150, and a rear flange, known as the rear bearing 160, belonging to the fixed housing of the electrical machine, which housing is connected to the earth. The bearings 150, 160 are perforated for internal ventilation of the alternator by means of the fans 8, 9 when the assembly of the fans 8, 9-rotor 4-shaft 2 is rotated by the pulley 11 connected to the motor vehicle engine by a transmission device comprising at least one belt engaged with the pulley 1. This ventilation makes it possible to cool the windings 12, 5, as well as the brush-holder 100 with its regulator and the rectifier device 110. Arrows in FIG. 1 represents the path followed by the cooling fluid, in this case air, through the various openings in the bearings 150, 160 and inside the machine.

This device 110, the brush-holder 100, as well as a perforated protective cover (with no reference) are in this case supported by the rear bearing 160, such that the rear fan 9 is more powerful than the front fan 8. In a known manner, the bearings 150, 160 are connected to one another, in this case by means of screws or tie rods, not shown, in order to form a housing which is designed to be fitted on a fixed part of the vehicle.

The bearings 150, 160 each support centrally a ball bearing 17, 18 in order to support in rotation the front and rear ends of the shaft 2 passing through the bearings 150, 160, in order to support the pulley 11 and the rings 10a, 10b of the collector 1.

These bearings have a hollow form, and in this case each have a perforated part with transverse orientation supporting the bearing 17, 18, and a perforated part with axial orientation, the diameter of which is stepped in its interior, in order to centre the stator 13 and retain it axially when the two bearings are connected together in order to form the housing.

The blades of the fans 8, 9 extend radially above the receptacles which the bearings 150, 160 have for fitting of the rollers 17 and 18, which are thus ventilated.

FIG. 2 represents the cylindrical core or body 14 of the stator 13 according to a plane perpendicular to the axis X-X. The cylindrical core of the stator comprises alternation of notches and teeth according to a circumferential direction, each notch being delimited by two teeth. In addition, each tooth is provided with two tooth roots extending circumferentially on both sides of the said tooth. According to this stator known to persons skilled in the art, the stator notches have parallel flanks. In other words, for each notch, the form of the pair of the two teeth which delimit the said notch is such that the notch has two parallel flanks.

The design of a rotary electrical machine comprises in particular a step of determination of the number of notches of the stator, a step of determination of the number of phases of the winding, a step of determination of the outer diameter of the yoke of the stator, and a step of determination of the dimensions of the notches and teeth of the stator. The determination of the dimensions of the notches and teeth of the stator must comply with a plurality of constraints, and in particular three. Firstly, the width of the teeth must be large enough to permit sufficient mechanical resistance, secondly, the width of the teeth must be sufficient to permit satisfactory conveying of the magnetic flux from the end of the teeth to the yoke, and thirdly, the notch surface area must be large enough to permit the introduction of a large quantity of copper wire, which prevents excessive resistance of the winding.

It appears that the optimum of each of these three constraints cannot be achieved separately. In fact, when wishing to increase the mechanical resistance and the magnetic flux conveyed from the end of the teeth to the yoke, large tooth widths are obtained, which, for a given outer diameter of the yoke and number of notches, results in notches with a surface area which is too small, thus inducing a substantial winding resistance and substantial losses by Joule effect. The contrary applies when it is wished to increase the surface area of a notch i.e. the width of the teeth for a given outer diameter of the yoke and number of notches is decreased, thus limiting considerably the magnetic flux conveyed from the end of the teeth to the yoke.

Determination of satisfactory dimensions of the notches and the teeth of the stator therefore consists of obtaining a good compromise with respect to these three constraints in particular. For example, the stator has dimensions of the notches and teeth of the stator illustrated in FIG. 2 which can be improved, since mainly these dimensions make possible only an increase in the surface area of the notch, i.e. an improvement in the coefficient of filling, but do not address the two other criteria. The invention proposes to eliminate the disadvantages of the known stators by providing a stator with improved dimensions of the notches and teeth of the stator, which fulfils the three above-described constraints.

### SUBJECT OF THE INVENTION

The subject of the invention is thus a stator for an alternator or an electrical machine, comprising:

a cylindrical core in which a plurality of slots which extend in the axial direction are formed;

a winding fitted in the said slots, wherein the said stator core comprises:

a cylindrical base part which forms a yoke;

a plurality of teeth arranged such as to extend from the said base part, towards an axial centre, and the said plurality of slots being defined by the said base part and by an adjacent pair of the said teeth.

According to a general characteristic of the invention, each notch, the width at the opening of the notch is smaller than the width at the yoke.

A good compromise is obtained, which makes it possible firstly to avoid saturation of the teeth at the ends of the teeth, such as to provide a substantial flux, and secondly to have a notch with a large surface area, which makes possible a larger cross-section of copper, thus allowing the phase resistance to be limited.

According to one embodiment, for each tooth, the width at the end is larger than the width at the yoke.

Because of this form, the flux which is conveyed by the teeth is optimised. In fact, the further away it is from the end, the less the magnetic flux is curbed by the saturation caused by the limited surface area of tooth. In fact, going away from the end of the tooth the radius increases, which, for a given width of tooth, has the effect of limiting the saturation. Thus, as far as a tooth is concerned, the most critical location for conveying the magnetic flux from the end of the tooth to the yoke is the end, whereas on the other hand the location where the constraints are the least important from this point of view is the yoke. Thus, by maximising the width of the tooth at its end and minimising it at the yoke, a maximum amount of flux conveyed is obtained, whilst having a large notch surface thanks to the recesses provided in the tooth. These recesses are due to the reduction of the width of the teeth at the yoke.

According to a characteristic of this embodiment, for each tooth, the ratio between the width at the end and the width at the yoke is between 1.8 and 2.2.

These ratios make possible a good compromise between a maximised flow conveyed, a good surface area of the notch, and satisfactory mechanical resistance.

According to another embodiment, for each tooth, the width at the end is smaller than the width at the yoke.

For a given minimum width of tooth, a configuration of this type makes possible an area of saturation over a lower height of tooth than with a tooth form with parallel flanks.

According to another embodiment, for each tooth, the width at the end is larger then the width of the tooth obtained at a position radially spaced from the yoke by a value of 0.3 and 0.7 times the height of the tooth.

This setback obtained by means of a reduction of the width of the tooth at an intermediate position between the end and the yoke, in comparison with the width of the tooth at the end, makes possible an increase in the surface area of the notch. However, a reduction of width of this type does not increase the saturation if it is implemented at a sufficient distance from the end of the tooth, since, when going away from the end of the tooth the radius increases, which has the effect for a given width of tooth of limiting the magnetic saturation.

According to another characteristic of this other embodiment, the minimum width of the tooth is obtained at a position radially spaced from the yoke by a value of between 0.4 and 0.6 times the height of the tooth.

The positioning of the minimum width at the height of the tooth thus makes possible minimisation of the increase in the magnetic saturation.

According to another characteristic of this embodiment, the ratio between the minimum width of the tooth and the width of the tooth at the end is between 0.2 and 0.7.

The ratio between the width at the end of the tooth and the minimum width makes possible a good compromise between the increase in the surface area of the notch and the increase in the magnetic saturation.

According to another embodiment, each tooth comprises on each of its sides a flank with a straight form with a constant direction and without a point of inflection.

This therefore provides ease of industrialisation and production.

According to a characteristic of this other embodiment, for each notch, the ratio between the width at the yoke and the width at the opening of the notch is between 1.1 and 2, and preferably between 1.3 and 1.5.

The ratio thus proposed makes possible an optimum compromise between electro-technical improvement and mechanical resistance.

According to another embodiment, the teeth have tooth roots at their end.

The widths of the tooth or the notch at the opening previously defined on the said axial centre side are understood to be measured just below the said tooth roots, not including the tooth roots. The tooth roots make possible an improvement in the electro-technical properties of the stator and retention of the wires in the notches.

According to a characteristic of this other embodiment, for each tooth, the circumferential width of the tooth root at the left of the tooth is different from the circumferential width of the tooth root at the right of the tooth.

The method for production of the stator comprises a step of installation of the winding in the notches. The differences of different circumferential widths then make it possible to facilitate this installation step when the winding comprises conductors formed by wires. For example in the case of an installation of the winding in the anticlockwise direction, a smaller tooth root at the right permits simpler introduction of the wires which form the conductors.

According to another characteristic of this other embodiment, the ratio between the circumferential width of the tooth root at the left of the tooth and the circumferential width of the tooth root at the right of the tooth is between 1.2 and 1.5.

A ratio of this type of the tooth root which is smaller at the right permits simpler introduction of the wires which form the conductors and also values of the tooth roots at the right and at the left which are not too different from one another provides a good compromise, or even preservation of the electromagnetic characteristics and retention in comparison with symmetrical tooth roots.

According to one embodiment, the flanks of the teeth are aligned with radii of the stator.

This arrangement is particularly advantageous in the case of a hexaphase winding.

The invention also relates to an electrical machine, for example an alternator comprising a rotor, and the said electrical machine comprises a stator as previously defined which surrounds the rotor.

According to one embodiment, the said winding which is fitted in the said slots of the cylindrical core of the stator comprises 6 phases.

According to another embodiment, the winding which is fitted in the said slots of the cylindrical core of the stator comprises conductors with a rectangular cross-section in the notches.

According to yet another embodiment, the winding which is fitted in the said slots of the cylindrical core of the stator comprises 4 or 6 conductors per notch.

### BRIEF DESCRIPTION OF THE FIGURES

The invention will be better understood by reading the following description and examining the figures which accompany it. These figures are provided purely by way of illustration, and in no way limit the invention.

FIG. 1, already described is a schematic view in transverse cross-section of a rotor of an electrical machine according to the prior art;

FIG. 2, already described, is a representation of the cylindrical core of a stator on a plane perpendicular to the axis X-X;

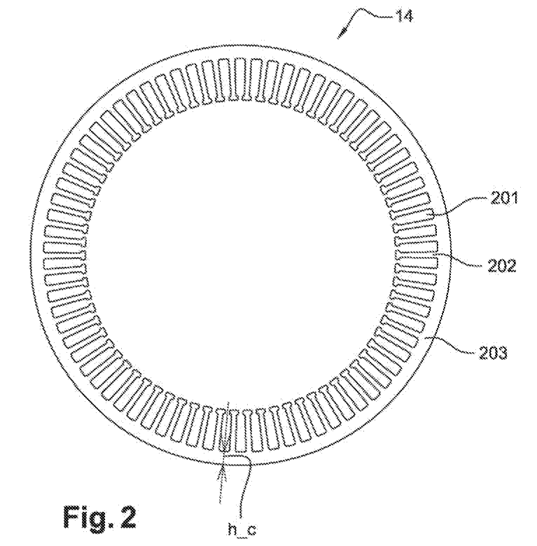

FIGS. 3 and 4 are representations of the cylindrical core of a stator according to the invention on a plane perpendicular to the axis X-X;

FIGS. 5 and 6 are representations of a tooth of the cylindrical core of a stator according to the invention on a plane perpendicular to the axis X-X; and

FIGS. 7 and 8 are representations of a notch provided with a winding according to the invention on a plane perpendicular to the axis X-X.

Elements which are identical, similar or analogous retain the same reference from one figure to another.

### DESCRIPTION OF EMBODIMENTS OF THE INVENTION

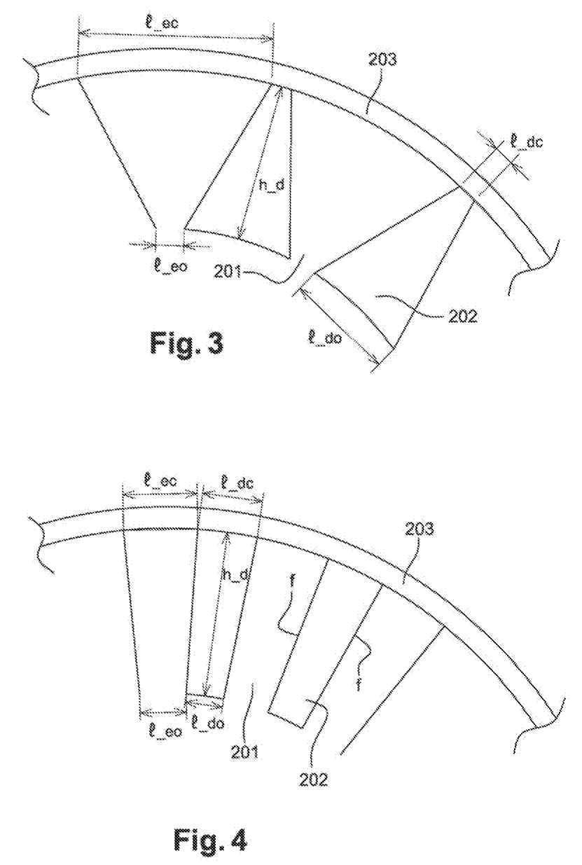

FIG. 3 is a representation of the cylindrical core 14 of a stator 13 on a plane perpendicular to the axis X-X.

The core 14 of the stator 13 comprises:

a cylindrical base part 203 forming a yoke, the said yoke having a radial thickness h_c:

a plurality of teeth 202 arranged such as to extend from the said base part towards an axial centre X-X, the said plurality of slots 201 being defined by the said base part 203 and by an adjacent pair of the said teeth 202.

As can be seen, firstly, for each notch 201, the width at the opening in the notch l_eo is smaller than the width l_ec at the yoke 203, and secondly, for each tooth 202, the width at the end l_do is larger than the width l_dc at the yoke.

For example, for each tooth 202, the ratio between the width at the end l_do and the width l_dc at the yoke 203 is between 1.8 and 2.2.

FIG. 4 is a representation of the cylindrical core 14 of a stator 13 on a plane perpendicular to the axis X-X.

The core 14 of the stator 13 comprises:

a cylindrical base part which forms a yoke 203;

a plurality of teeth 202 arranged such as to extend from the said base part 203 towards an axial centre X-X, the said plurality of slots 201 being defined by the said base part 203 and by an adjacent pair of the said teeth 202.

As can be seen, firstly, for each slot which forms a notch 201, the width at the opening of the notch l_eo is smaller than the width l_ec at the yoke 203, and secondly, for each tooth 202, the width at the end l_do is smaller than the width l_dc at the yoke 203.

In addition, each tooth 202 comprises on each of its sides a flank f with a straight form with a constant direction and without a point of inflection.

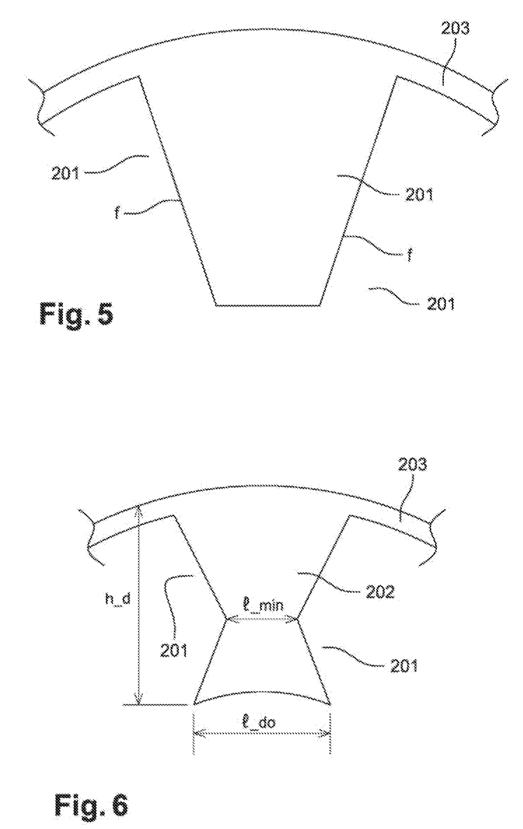

FIG. 5 is a representation of a tooth 202 of the cylindrical core illustrated in FIG. 4. As can be seen, for each tooth 202, the width at the end l_do is smaller than the width l_dc at the yoke 204.

For example, the ratio between the width l_ec at the yoke 204 and the width at the opening of the notch l_eo is between 1.1 and 2, and preferably between 1.3 and 1.5.

FIG. 6 is a representation of a tooth 202 of the cylindrical core 14 of a stator 13 on a plane perpendicular to the axis X-X. As can be seen, for each tooth, the width at the end l_do is smaller than the width l_dc at the yoke.

According to FIG. 6, the width at the end l_do is larger than the width of the tooth 202 obtained at a position radially spaced from the yoke by a value of between 0.3 and 0.7 times the height of the tooth h_d.

According to a preferred embodiment, the minimum width l_min of the tooth 202 is obtained at a position radially spaced from the yoke by a value of between 0.4 and 0.6 times the height of the tooth h_d.

For example, the ratio between the minimum width l_min of the tooth 202 and the width of the tooth at the end l_do is between 0.2 and 0.7.

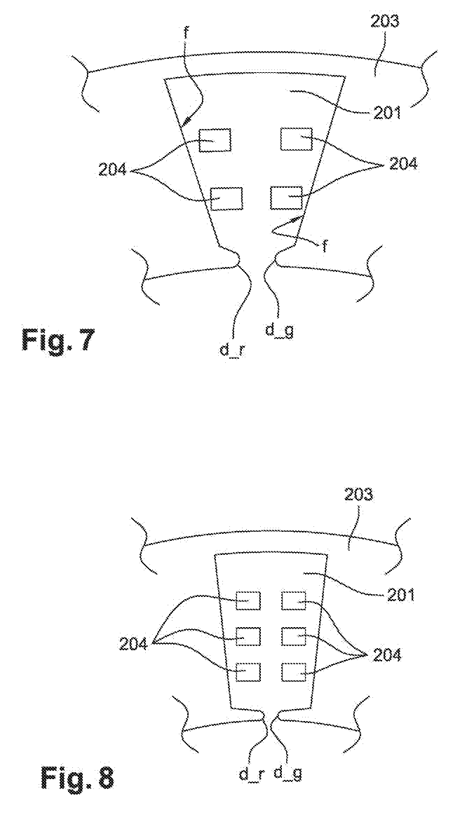

FIG. 7 is a representation of a notch 201 provided with a winding on a plane perpendicular to the axis X-X. The notch 201 illustrated in FIG. 7 is delimited by two teeth. The two teeth 202 each comprise at their end, and at the two circumferential sides of these ends, a tooth root d_r and d_g respectively. In FIG. 7, only one flank f of each tooth 202 is illustrated, such that for each of them only one tooth root, i.e. the one of the flank illustrated, is shown in FIG. 7.

Advantageously, for each tooth 202, the circumferential width of the tooth root at the left d_g of the tooth 202 is different from the circumferential width of the tooth root at the right d_r of the tooth. For example, the ratio between the circumferential width of the tooth root at the left of the tooth and the circumferential width of the tooth root at the right of the tooth is between 1.2 and 1.5.

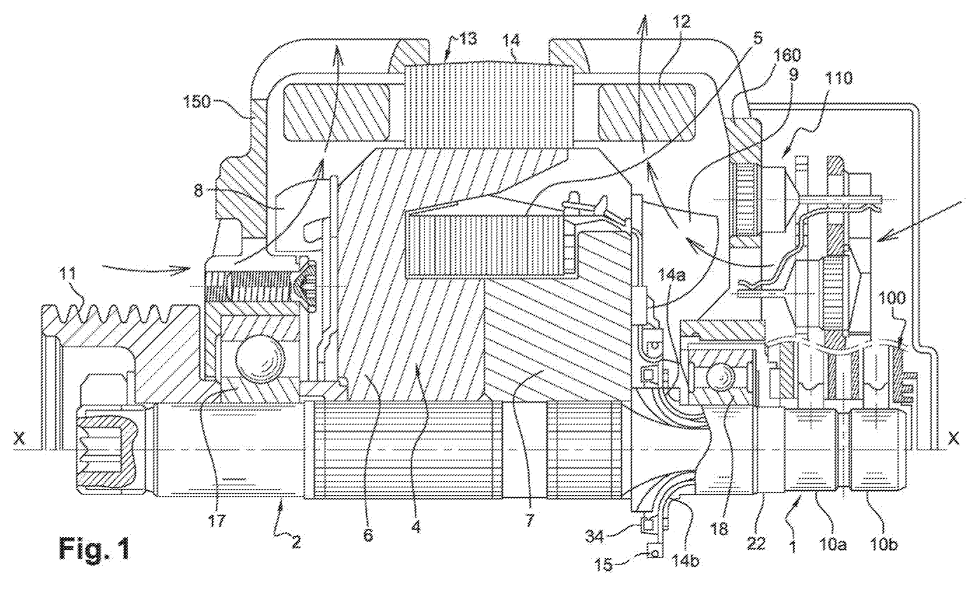

The notch of the stator 13 illustrated in FIG. 7 is incorporated in an electrical machine, for example an alternator, as illustrated in FIG. 1, which comprises a rotor, the said stator surrounding the said rotor 4. The electrical machine comprises a winding 12 which is fitted in the said slots 201 of the cylindrical core 14 of the stator which comprises 6 phases. For example, the winding 12 which is fitted in the said slots 201 of the cylindrical core of the stator 14 comprises conductors 204 which have a rectangular cross-section in the notches. Advantageously, the winding 12 which is fitted in the said slots 201 of the cylindrical core of the stator comprises 4 conductors per notch. In the case when the winding 12 comprises 4 conductors 204 aligned radially in the notch 201 according to two columns of two conductors 204, a winding of this type is classified as a quad.

FIG. 8 is a representation of a notch 201 provided with a winding on a plane perpendicular to the axis X-X. The notch 201 provided with a winding in FIG. 8 is distinguished from the one illustrated in FIG. 7 by the number of conductors 204 per notch 201, which is 6 for FIG. 8, whereas it is 4 for FIG. 7. These conductors 204 are advantageously aligned radially in the notch 201 according to two columns of three conductors 204.

1. Stator (13) for an alternator or an electrical machine, comprising:
a cylindrical core (14) in which a plurality of slots (201) forming notches which extend in the axial direction are formed;
a winding (12) fitted in said notches, wherein said stator core (14) comprises:
a cylindrical base part (203) which forms a yoke (203);
a plurality of teeth (202) arranged such as to extend from said base part, towards an axial centre (X-X), and said plurality of slots (201) being defined by said base part and by an adjacent pair of said teeth (202); wherein, for each notch (201), the width at the opening of the notch (l_eo) is smaller than the width (l_ec) at the yoke (203).

2. Stator according to claim 1, wherein, for each tooth (202), the width at the end (l_do) is larger than the width (l_dc) at the yoke (203).

3. Stator according to claim 1, wherein, for each tooth (202) the ratio between the width at the end (l_do) and the width (l_dc) at the yoke (203) is between 1.8 and 2.2.

4. Stator according to claim 1, characterised in that wherein, for each tooth (202), the width at the end (l_do) is smaller than the width (l_dc) at the yoke (203).

5. Stator according to claim 4, wherein, for each tooth (202), the width at the end (l_do) is larger than the width of the tooth (202) obtained at a position radially spaced from the yoke (203) by a value of between 0.3 and 0.7 times the height of the tooth (h_d).

6. Stator according to claim 4, wherein the minimum width (l_min) of the tooth (202) is obtained at a position radially spaced from the yoke (203) by a value of between 0.4 and 0.6 times the height of the tooth (h_d).

7. Stator according to claim 6, wherein the ratio between the minimum width of the tooth (l_min) and the width of the tooth at the end (l_de) is between 0.2 and 0.7.

8. Stator according to claim 4, wherein each tooth comprises on each of its sides a flank (f) with a straight form with a constant direction and without a point of inflection.

9. Stator according to claim 4, wherein, for each notch (201), the ratio between the width (l_ec) at the yoke (203) and the width at the opening of the notch (l_eo) is between 1.1 and 2, and preferably between 1.3 and 1.5.

10. Stator according to claim 1, wherein the teeth (202) have tooth roots (d_r, d_g) at their end.

11. Stator according to claim 10, wherein, for each tooth (202), the circumferential width of the tooth root (d_g) at the left of the tooth is different from the circumferential width of the tooth root (d_r) at the right of the tooth.

12. Stator according to claim 11, wherein the ratio between the circumferential width of the tooth root (d_g) at the left of the tooth and the circumferential width of the tooth root (d_r) at the right of the tooth is between 1.2 and 1.5.

13. Electrical machine, for example an alternator, which comprises a rotor (4), comprising a stator (13) according to claim 1, said stator surrounding said rotor (4).

14. Electrical machine according to claim 13, wherein said winding (12) which is fitted in the said slots (201) of the cylindrical core (14) of the stator comprises 6 phases.

15. Electrical machine according to claim 14, wherein said winding (12) which is fitted in the said slots (201) of the cylindrical core (14) of the stator comprises conductors (204) with a rectangular cross-section in the notches.

16. Electrical machine according to claim 14, wherein said winding (12) which is fitted in said slots (201) of the cylindrical core of the stator (14) comprises 4 or 6 conductors (204) per notch.

17. Stator according to claim 2, wherein, for each tooth (202) the ratio between the width at the end (l_do) and the width (l_dc) at the yoke (203) is between 1.8 and 2.2.

18. Stator according to claim 5, wherein the minimum width (l_min) of the tooth (202) is obtained at a position radially spaced from the yoke (203) by a value of between 0.4 and 0.6 times the height of the tooth (h_d).
